(19) United States
(12) Patent Application Publication
(10) Pub. No.: US 2009/0108170 A1
(43) Pub. Date: Apr. 30, 2009

(54) Concrete forming system

(76) Inventor: Blayde Penza, Sun Valley, CA (US)

Correspondence Address: JAMES E. BRUNTON, ESQ., P. O. BOX 29000, GLENDALE, CA, 91209, US

(21) Appl. No.: 11/977,255

(22) Filed: Oct. 25, 2007

(51) Int. Cl. E04G 13/02; B41B 11/54; E04G 21/02

(52) U.S. Cl. 249/48; 249/173; 52/742.14

(57) ABSTRACT

A lightweight forming system and the method of using same that can be used to construct concrete columns of various external shapes. The system includes a reusable, flexible securement jacket that can be wrapped around a rigid concrete receiving component having a concrete receiving chamber into which the concrete is poured. The securement jacket of the system can be quickly and easily removed as soon as the concrete has sufficiently cured and can then be immediately reused to pour another column. Following use, the securement jacket can be rolled into a tight bundle for transport and storage.

### BACKGROUND OF THE INVENTION

1. Field of the Invention

The present invention relates generally to a concrete forming apparatus and the method of using the same. More particularly, the invention concerns a concrete forming apparatus that is especially well suited for use in forming concrete support columns.

2. Discussion of the Prior Art

A common practice in the construction industry is to use specially constructed wooden forms, or alternatively, elongate paper fiber tubes to form concrete columns. The use of wooden forms is generally quite time consuming and cost ineffective. While the use of paper fiber tubes is more efficient than the use of wooden forms, these paper fiber tubes are typically very bulky and are quite cumbersome to handle and transport. Additionally, the tubes are quite expensive and can be used only once and then scrapped.

Once the tube is in place and properly anchored, concrete is poured into the interior of the tube and allowed to harden so as to form a column. After the concrete has hardened, the tube is stripped away from the concrete column and discarded.

Obviously, the use of the paper fiber tubes produces a generally cylindrically shaped column with a relatively smooth outer surface. In order to use the conventional paper fiber tubes to produce other than a cylindrically shaped column, the Sonico Company of Hartsville, S.C. has developed a concrete form that comprises a paper fiber tube having an elongate, square fiberboard insert that is locked in place with polystyrene. The use of these modified paper fiber tubes enables the formation of substantially rectangular-shaped columns.

The thrust of the present invention is to provide a novel, lightweight, forming system that includes a reusable, flexible jacket that can be secured about a selected Styrofoam shape into which the concrete is poured. By using Styrofoam shapes of various configurations, concrete columns of selected external shapes can readily be formed.

### SUMMARY OF THE INVENTION

It is an object of the present invention to provide a novel, lightweight forming system and the method of using same that can be used to construct concrete columns of various external shapes.

Another object of the invention is to provide a system of the aforementioned character which comprises a reusable, flexible securement jacket that can be wrapped around a Styrofoam shape into which the concrete is poured.

Another object of the invention is to provide a method and apparatus of the character described in the preceding paragraphs in which the securement jacket of the apparatus can be quickly and easily removed as soon as the concrete has sufficiently cured and can be immediately reused to pour another column.

Another object of the invention is to provide an apparatus of the class described that is easy-to-use, easy to store and easy to transport. More particularly, it is an object of the invention to provide a securement jacket of the character described that can be rolled into a tight bundle for transport and storage.

Another object of the invention is to provide a novel, lightweight forming system that is particularly useful in replacing existing wooden columns that are used to support an overhead structure with concrete columns of selected exterior design.

Another object of the invention is to provide a forming system and a method of using the system as described in the preceding paragraph which can be used to replace existing wooden columns supporting an overhead structure without the necessity of removing, or damaging the existing overhead structure.

### BRIEF DESCRIPTION OF THE DRAWINGS

FIG. 1 is a generally perspective, foreshortened view of one form of the securement component of the concrete forming system of the invention.

FIG. 2 is a generally perspective view of a prior art overhead structure embodying a plurality of wooden vertical support members the character of which are replaced by concrete columns formed in accordance with one form of the method of the present invention.

FIG. 3 is a generally perspective, foreshortened view illustrating one step of one form of the method of the invention for replacing rotted wooden vertical support members with concrete columns using the concrete forming system of the present invention.

FIG. 4 is a generally perspective, foreshortened view illustrating the next step of one form of the method of the invention for replacing rotted wooden vertical support members wherein the Styrofoam insert component of the apparatus of the invention is positioned about the structure illustrated in FIG. 3.

FIG. 5 is a generally perspective, foreshortened view illustrating the next sequential step of one form of the method of the invention for replacing rotted wooden vertical support members wherein the securement component of the apparatus of the invention is positioned about the structure illustrated in FIG. 4.

FIG. 6 is an enlarged cross-sectional view taken along lines 6-6 of FIG. 5.

FIG. 7 is a cross-sectional view of an alternate form of column shape that can be produced in accordance with the method of the present invention.

FIG. 8 is a cross-sectional view of still another form of column shape that can be produced in accordance with the method of the present invention.

FIG. 9 is a cross-sectional view of yet another form of column shape that can be produced in accordance with the method of the present invention.

FIG. 10A is a greatly enlarged, generally perspective view of the area designated as 10A-10A in FIG. 1.

FIG. 10B is a view similar to FIG. 10A but showing the next step in the operation of one of the adjustable latches of the invention.

FIG. 10C is a view similar to FIG. 10B but showing the final step in the operation of the adjustable latch.

### DESCRIPTION OF THE INVENTION

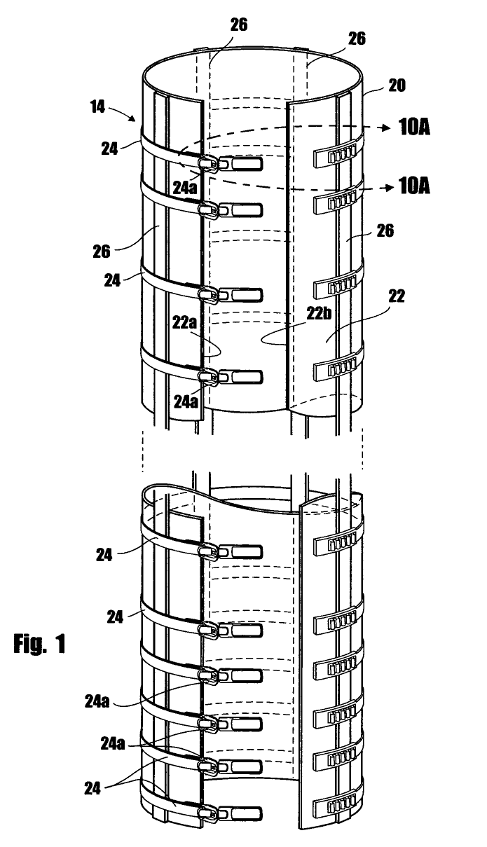

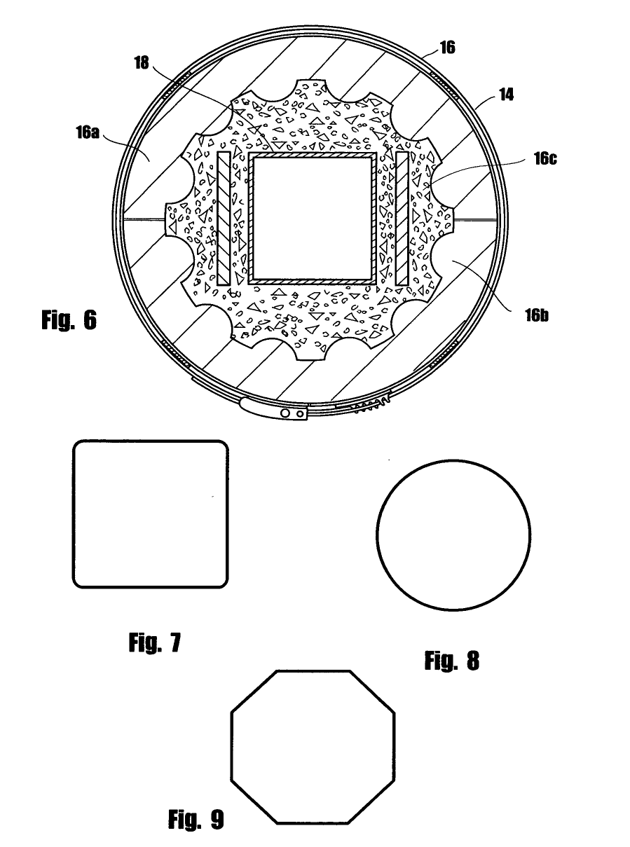

Referring to the drawings and particularly to FIGS. 1, 3, 4 and 5, the various components of one form of the apparatus of the invention for constructing a concrete column are there shown. One of the most important and unique components of the apparatus is the novel securement component 14 the character of which it is shown in FIG. 1 of the drawings. The details of the construction and operation of this important securement component will presently be described. FIG. 6 of the drawings shows the securement component 14 of the concrete forming system of the invention encircling the equally important, rigid elongate member 16 of the invention. Member 16 has a concrete receiving chamber 16a that is here shown as being generally fluted in cross-section and within which an elongate metal reinforcing member 18 is centrally disposed. It is to be understood that the concrete receiving chamber can also be generally rectangular in cross-section (FIG. 7), can be generally circular in cross-section (FIG. 8) and can be generally octagonal in cross-section (FIG. 9). It is apparent that the shape of the concrete receiving chamber dictates the shape of the outer surface of the concrete column that is to be formed in accordance with the method of the invention.

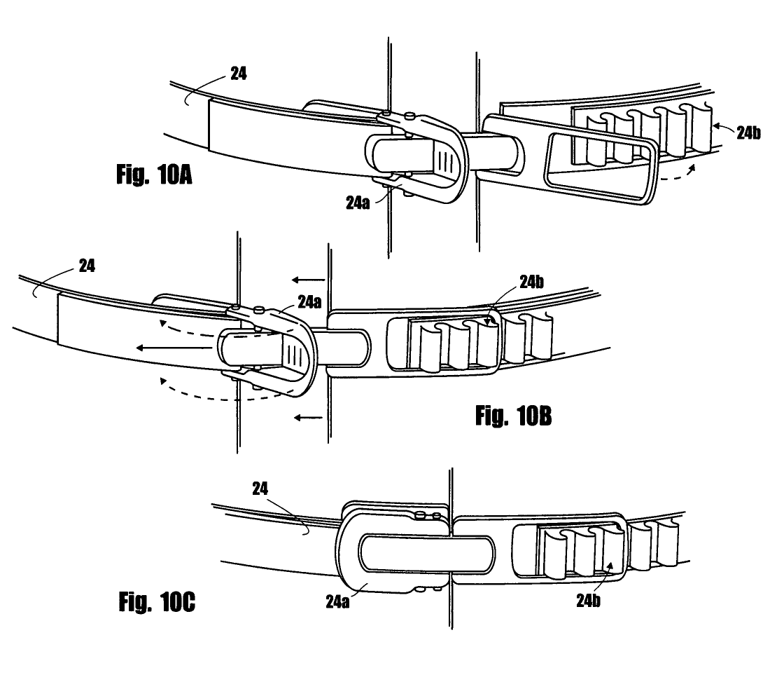

As best seen in FIG. 1 of the drawings, securement component 14 here comprises a reusable, flexible securement jacket 20 that includes a body portion 22 having lateral edges 22a and 22b. Securement jacket 20 also includes connector means for interconnecting the lateral edges to secure the securement jacket in position about the rigid elongate member 16 in the manner shown in FIG. 6. As best seen in FIG. 1, the connector means here comprises a plurality of longitudinally spaced-apart connector straps 24 to which a plurality of conventional adjustable latches 24a are connected (see also FIGS. 10A, 10B and 10C). In the present form of the invention, the connector means also comprise a plurality of conventional latch engaging elements 24b that are also carried by the spaced-apart connector straps 24 (see FIGS. 5, 10A, 10B and 10C). The connector straps, the adjustable latches and the latch engaging elements are constructed and arranged so that the adjustable latches 24a are positioned proximate the lateral edge 22a of the flexible body portion 22 and the latch engaging elements 24b are positioned proximate the lateral edge 22b of the flexible body portion. Adjustable latches 24a as well as latch engaging elements 24b are readily commercially available from hardware stores and building supply outlets. As also shown in FIG. 1, reusable, flexible securement jacket 20 further includes plurality of circumferentially spaced-apart, generally longitudinally extending steel reinforcing straps 26 that are connected to body portion 22 in the manner shown in FIG. 1.

Securement jacket 20 can be constructed from various durable materials, such as canvas and like materials. Rigid elongate member 16, which comprises first and second cooperating portions 16a and 16b (See FIG. 6), can also be constructed from various materials, but preferably is constructed from a lightweight foam material such as Styrofoam.

Considering now one form of the method of the invention for constructing a vertically extending concrete column. In the simplest form of the method of the invention, the two halves 16a and 16b of the rigid elongate member 16 are joined together and disposed in a generally vertical orientation. This done, the securement component 14 is wrapped around the elongate member in the manner illustrated in FIG. 6. The assemblage thus formed takes the place of the elongate paper fiber tubes typically used in prior art concrete column forming methods.

With the securement component in position around the Styrofoam elongate member 16 in a manner so as to substantially prevent expansion of the rigid elongate member, the latches 24a are interconnected with the latch engaging elements 24b so as to secure together the lateral edges of the securement jacket in the manner illustrated in FIGS. 10A, 10B and 10C of the drawings. The latches and the latch engaging elements are constructed and arranged so that they effectively function to bring the securement jacket 20 into secure pressural engagement with the elongate member 16. Next, the concrete is poured into the concrete receiving chamber 16c (FIG. 6) formed interiorly of the elongate member 16, and the flexible securement jacket is maintained in position about the rigid elongate member for a period of time sufficient to allow the concrete to set-up to form a hardened concrete column.

Once the concrete has set up, the latches 24a are manipulated so that the securement jacket can be removed from its position about the elongate member 16. Once removed, the securement jacket can be rolled into a compact roll for transport and storage pending its next use. With the securement jacket removed from about the elongate member 16, the two halves of the elongate member can be separated from the concrete column and appropriately stored for subsequent use.

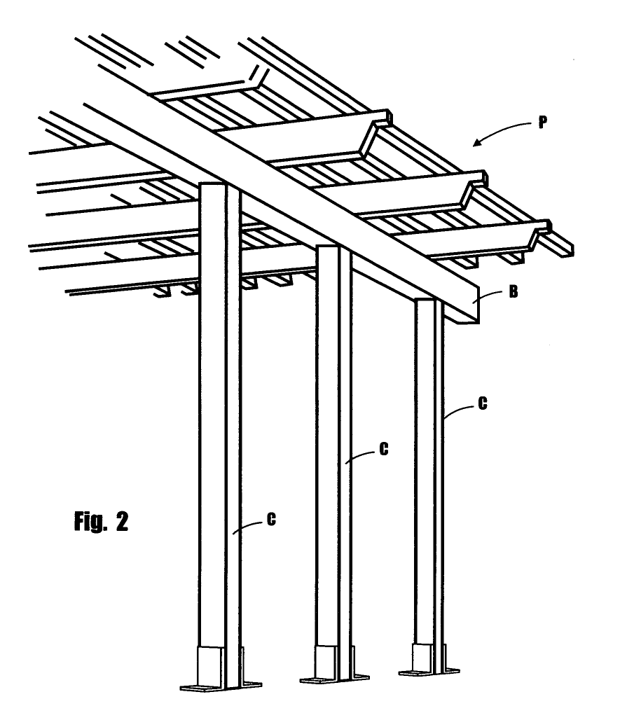

Another form of the method of the present invention is illustrated in FIGS. 2, 3, 4 and 5 of the drawings. This method involves the replacement with concrete columns of defective existing wooden columns, such as the columns “C” shown in FIG. 2 of the drawings, that are used to support an overhead beam “B”, of a structure such as the patio structure “P”.

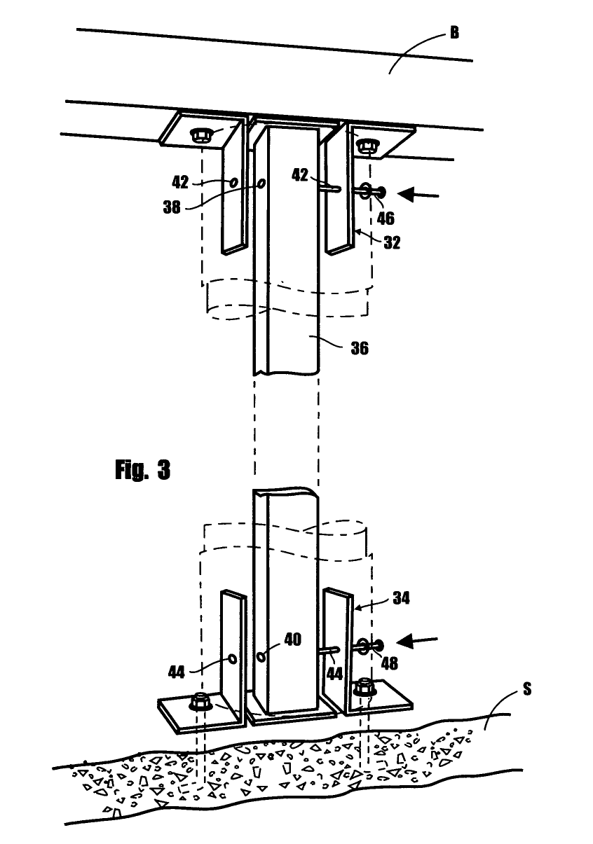

Following removal of one of the effective existing wooden columns, the first step in this alternate method of the invention is to affix to the overhead beam a first pair of spaced-apart “L” brackets 32 (see FIG. 3). This done a second pair of spaced-apart “L” brackets 34 are affixed to the concrete slab “S” at a location directly beneath the spaced-apart brackets 32. Next, a metal reinforcing member 36 is positioned within the brackets 32 and 34 and beneath the beam “B” in the manner illustrated in FIG. 3 of the drawings. As indicated in FIG. 3, metal reinforcing member 36, is provided with upper and lower through bores 38 and 40 respectively that are located so as to align with bolt receiving apertures 42 and 44 respectively formed in brackets 32 and 34. An upper bolt 46, which is receivable through apertures 42 formed in upper brackets 32 and through upper bore 38 formed in reinforcing member 36, functions to secure the reinforcing member to the upper brackets. In similar fashion, a lower bolt 48, which is receivable through apertures 44 formed in lower brackets 34 and through lower bore 40 formed in reinforcing member 36, functions to secure the reinforcing member to the lower brackets.

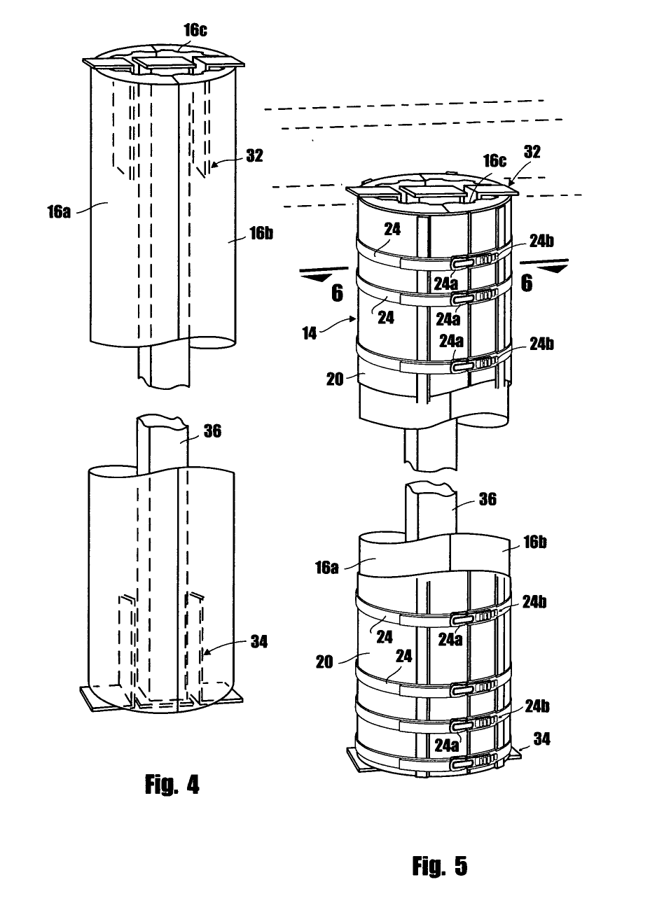

Once the bolts 46 and 48 have been appropriately secured to brackets 32 and 34, the next step in this latest form of the method of the invention is to place the two halves 16a hand 16b of the Styrofoam support member 16 about the assemblage shown in FIG. 3 and comprising the reinforcing member 36 and the brackets 32 and 34 (see FIG. 4). This done, the securement component 14 is wrapped around the elongate member in the manner illustrated in FIG. 5. As before, the assemblage thus formed takes the place of the elongate paper fiber tubes typically used in prior art concrete column forming methods.

With the securement component in the circumscribing position around the Styrofoam elongate member 16 so as to substantially prevent expansion of the rigid elongate member, the latches 24a are interconnected with the latch engaging elements 24b in the manner illustrated in FIGS. 10A, 10B and 10C of the drawings so that the securement jacket 20 is brought into secure pressural engagement with the elongate member 16. Next, the concrete can be poured into the concrete receiving chamber 16c (FIG. 6) formed interiorly of the elongate member 16 and allowed to set up in a normal fashion. If necessary, a metal guide shoot (not shown) can be used to guide the concrete into the concrete receiving chamber 16c.

Once the concrete has set up, the latches 24a are manipulated so that the securement jacket can be removed from its position about the elongate member 16. Once removed, the securement jacket can be rolled into a compact roll for transport and storage pending its next use. With the securement jacket removed from about the elongate member 16, the two halves of the elongate member can be separated from the concrete column and appropriately stored for subsequent use.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. An apparatus for constructing a concrete column comprising:
(a) a rigid elongate member having a concrete receiving chamber; and
(b) a reusable, flexible securement jacket for circumscribing said rigid elongate member, said flexible securement jacket having lateral edges and connector means for interconnecting said lateral edges to secure said securement jacket in position about said rigid elongate member.

2. The apparatus as defined in claim 1 in which said rigid elongate member is constructed from a lightweight foam material.

3. The apparatus as defined in claim 1 in which said rigid elongate member comprises first and second cooperating portions.

4. The apparatus as defined in claim 1 in which said reusable, flexible securement jacket further comprises a flexible body portion having plurality of spaced-apart, generally longitudinally extending steel straps connected to said body portion.

5. The apparatus as defined in claim 1 in which said flexible securement jacket comprises a flexible body portion having lateral edges and in which said connector means comprises a plurality of longitudinally spaced-apart, adjustable latches connected to said flexible body portion proximate said lateral edges thereof.

6. The apparatus as defined in claim 1 in which said concrete receiving chamber is generally circular in cross section.

7. The apparatus as defined in claim 1 in which said concrete receiving chamber is generally fluted in cross section.

8. The apparatus as defined in claim 1 in which said flexible securement jacket is constructed from a canvas material, said method comprising the steps of positioning the rigid elongate member in a substantially vertical position; circumscribing the rigid elongate member with the securement jacket; interconnecting the lateral edges of the securement jacket to substantially prevent expansion of the rigid elongate member; pouring concrete into the concrete receiving chamber of the rigid elongate member; permitting the concrete to set-up to form a concrete column; removing the flexible securement jacket from about the rigid elongate member; and removing the rigid elongate member from said concrete column.

9. A method of constructing a concrete column through the use of a reusable concrete forming apparatus comprising a rigid elongate member having a concrete receiving chamber and a flexible securement jacket having lateral edges, said method comprising the steps of positioning the rigid elongate member in a substantially vertical position; circumscribing the rigid elongate member with the securement jacket; interconnecting the lateral edges of the securement jacket to substantially prevent expansion of the rigid elongate member; pouring concrete into the concrete receiving chamber of the rigid elongate member; permitting the concrete to set-up to form a concrete column; removing the flexible securement jacket from about the rigid elongate member; and removing the rigid elongate member from said concrete column.

10. A method for replacing a wooden post disposed between a supporting base and an overhead structure with a concrete column through the use of a reusable concrete forming apparatus comprising a rigid elongate member having a concrete receiving chamber and a flexible securement jacket having lateral edges, said method comprising the steps of:
(a) removing the wooden post;
(b) positioning a temporary reinforcing member between the supporting base and the overhead structure;
(c) positioning a metal reinforcing member between the supporting base and the overhead structure;
(d) positioning the rigid elongate member around the metal reinforcing member in a manner such that said metal reinforcing member is disposed generally centrally of the concrete receiving chamber;
(e) positioning the flexible securement jacket around the rigid elongate member and interconnecting the lateral edges thereof in a manner to substantially prevent outward expansion of the rigid elongate member;
(f) pouring concrete into the concrete receiving chamber of the rigid elongate member;
(g) maintaining the flexible securement jacket in position about the rigid elongate member for a period of time sufficient to allow the concrete to set-up to form a hardened concrete column;
(h) removing the flexible securement jacket from about the rigid elongate member; and
(i) removing the rigid elongate member from about the hardened concrete column.
